(19) United States
(12) Patent Application Publication
(10) Pub. No.: US 2009/0210367 A1
(43) Pub. Date: Aug. 20, 2009

(54) Method for Automatically Characterizing the Behavior of One or More Objects

(76) Inventors: James Douglas Armstrong, Edinburgh (GB); Dean Adam Baker, Edinburgh (GB); James Alexander Heward, Edinburgh (GB)

Correspondence Address: HARRINGTON & SMITH, PC, 4 RESEARCH DRIVE, Suite 202, SHELTON, CT, 06484-6212, US

(21) Appl. No.: 12/225,625

(22) PCT Filed: Mar. 28, 2006
(86) PCT No.: PCT/GB2006/001113

§ 371 Date: Mar. 30, 2009

(51) Int. Cl. G06N 3/12; G06F 15/18; G06N 5/02

(52) U.S. Cl. 706/13; 706/12; 706/54

(57) ABSTRACT

Automatically characterizing a behavior of an object or objects by processing object data to obtain a data set that records a measured parameter set for each object over lime, providing a learning input that identifies when the measured parameter set of an object is associated with a behavior, processing the data set in combination with the learning input to determine which parameters of the parameter set over which range of respective values characterize the behavior; and sending information that identifies which parameters of the parameter set over which range of respective values characterize the behavior for use in a process that uses the characteristic parameters and their characteristic ranges to process second object data and automatically identify when the behavior occurs. Also disclosed is a method of tracking one or more objects.

### FIELD OF THE INVENTION

Embodiments of the present invention relate to a computer implemented method for automatically characterizing the behavior of objects.

### BACKGROUND TO THE INVENTION

The detailed analysis of courtship behavior in the fruit-fly Drosophila melanogaster is a prime example of a behavior that is routinely used in scientific research. In our research it is used to give us an indication of neuronal function. In common with other behaviors measured in the laboratory and in the wild, it involves time consuming and somewhat subjective manual scoring procedures by trained expert staff. This is clearly an expensive and unreliable process that we want to minimize in modern research.

For example, WO 02/43352 (Clever Sys) describes how to classify the behaviour of an object using video. Experts must first identify and classify various behaviours of a standard object both qualitatively and quantitatively, for example, a mouse's behaviours may include standing, sitting, lying, normal, abnormal, etc. This is a time consuming process. When a new video clip is analyzed, the system first obtains the video image background and uses it to identify a foreground object. Analysis of the foreground object may occur in a feature space, from frame to frame, where the features include centroid, principal orientation angle of object, area etc. The obtained features are used to classify the state of the mouse into one of the predefined classifications.

Automated analysis of behavior in this way has a number of restrictions, and it would be desirable to address such issues for analyzing behavior in live organisms or other moving objects as outlined in the current invention.

A first problem to be addressed is how to efficiently identify an appropriate reduced temporal-spatial dataset into which a video sequence of objects can be reduced to characterize their interactions.

A second problem is how to automatically identify, using a computer, individual objects when one object may at least partially occlude another object at any time.

### BRIEF DESCRIPTION OF THE INVENTION

According to one embodiment of the invention there is provided a method for automatically characterizing a behavior of objects, comprising: processing object data to obtain a data set that records a measured parameter set for each object over time; providing a learning input that identifies when the measured parameter set of an object is associated with a behavior; processing the data set in combination with the learning input to determine which parameters of the parameter set over which range of respective values characterize the behavior; and sending information that identifies which parameters of the parameter set over which range of respective values characterize the behavior for use in a process that uses the characteristic parameters and their characteristic ranges to process second object data and automatically identify when the behavior occurs.

This enables dynamic characterization using machine learning techniques and removes the need for a predefined model of any specific behavior.

The processing of the data set in combination with the learning input dynamically determines which parameters of the parameter set over which range of respective values characterize the behavior. The characterizing parameters may thus change dynamically during the process and are not predetermined.

The learning input need only identify when a behavior occurs. The burden on an expert is therefore only that the expert should indicate when the behavior is occurring. The expert does not have to determine why they believe the behavior is occurring. The burden of classifying a behavior is thus moved from the expert to the processing step.

Object data may be a video clip or clips. Alternatively object data may be other data that records the motion of one or more objects over time. It may, for example, include a sequence of Global Positioning System (GPS) coordinates for each object. The behavior may be the interaction of moving objects such as biological organisms.

Processing the data set in combination with the learning input to determine which parameters of the parameter set over which range of respective values characterize the interaction may involve the use of a learning system such as, but not restricted to, a genetic algorithm.

The chromosomes used in the genetic algorithm may comprise a gene for each of the parameters in the measured parameter set that may be switched on or off. The chromosomes used in the genetic algorithm may comprise a gene that specifies the number of clusters of parameters necessary for characterizing the interaction. The chromosomes used in the genetic algorithm may comprise a gene that specifies the time period over which the fitness of a chromosome is assessed.

A chromosome from the population of chromosomes used by the genetic algorithm, may define a parameter space and how many clusters the parameter space is divided into. The extent to which the sub-set of the data set that lies within the clusters correlates with the sub-set of the data set associated with an interaction may be used to determine the fitness of the chromosome.

According to one embodiment of the invention there is provided a method of tracking one or more objects comprising: processing first data to identify discrete first groups of contiguous data values that satisfy a first criterion or first criteria; processing a second subsequent data to identify discrete second groups of contiguous data values that satisfy a second criterion or second criteria; performing mappings between the first groups and the second groups; using the mappings to determine whether a second group represents a single object or a plurality of objects; measuring one or more parameters of a second group when it is determined that the second group represents a single object; processing a second group, when it is determined that the second group represents N (N>1) objects, to resolve the second group into N subgroups of contiguous data values that satisfy the second criterion or second criteria; measuring the one or more parameters of the sub groups; and mapping the plurality of subgroups to the plurality of objects.

The method classifies all behaviors social and individual as interactions of objects. One approach for all types of behavior is used.

As an individual can be composed of many component-objects, then a graph of the objects in the scene can be built, for example a scene may contain two objects, each of which is composed of a head and body object. This allows one to create a hierarchy of objects and examine not only the interactions of complete objects but the interactions of a component-object with either a component of another object or a component of the complete object itself. A complete-object composed of component-objects inherits all the properties of the component-object and may have additional characteristics which can be defined given the class of object (e.g. Mouse, fly) of the complete-object.

### BRIEF DESCRIPTION OF THE DRAWINGS

For a better understanding of the present invention reference will now be made by way of example only to the accompanying drawings in which:

FIG. 1A schematically illustrates a tracking system;

FIG. 1B schematically illustrates a processing system 110;

FIG. 2 schematically illustrates a tracking process;

FIGS. 3A and 3B illustrate the labeling of pixel values;

FIG. 4 illustrates a data structure output from the tracking process; and

FIG. 5 schematically illustrates a set-up and behavioral evaluation process.

### DETAILED DESCRIPTION OF EMBODIMENTS OF THE INVENTION

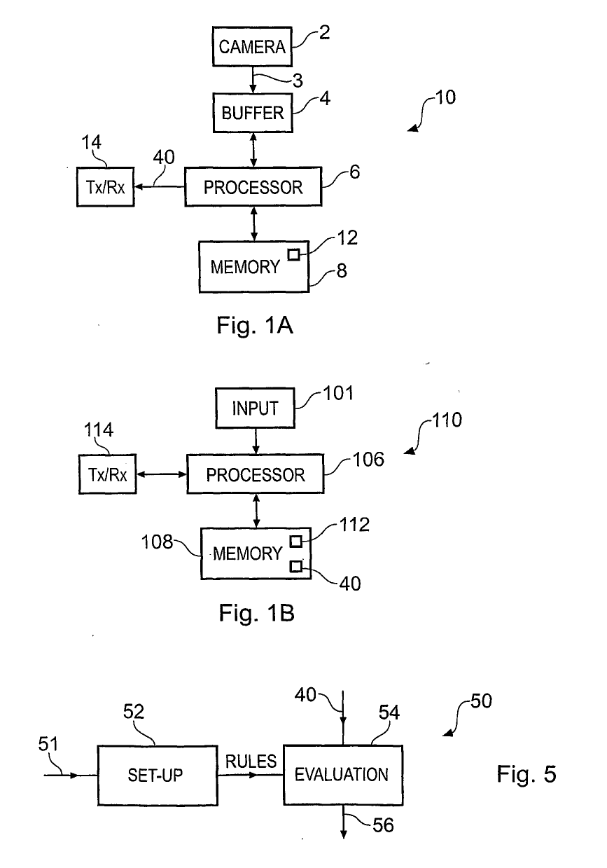

FIG. 1A illustrates a tracking system 10 suitable for performing image capture and analysis.

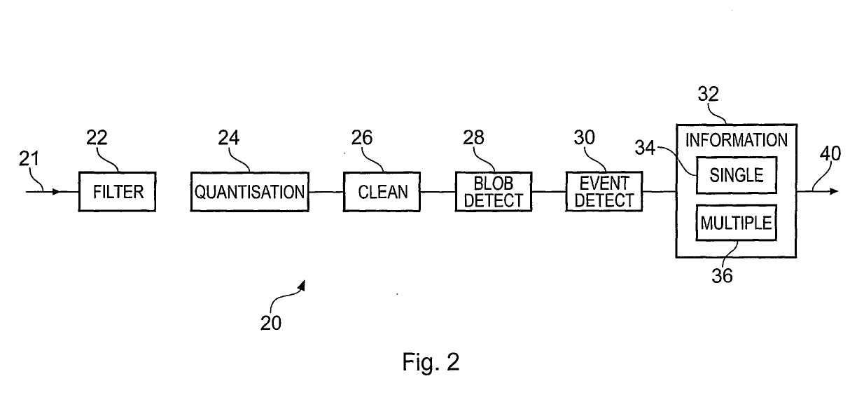

The system comprises a video camera 2, a memory buffer 4 for buffering the video images supplied by the camera before being passed to a processor 6. The processor 6 is connected to read from and write to a memory 8. The memory 8 stores computer program instructions 12. The computer program instructions 12 control the operation of the system 10 when loaded into the processor 6. The computer program instructions 12 provide the logic and routines that enables the electronic device to perform the methods illustrated in FIG. 2.

The computer program instructions may arrive at the system 10 via an electromagnetic carrier signal or be copied from a physical entity such as a computer program product, a memory device or a record medium such as a CD-ROM or DVD or be transferred from a remote server.

The tracking system 10 described below has been designed for use in a remote location. As a result, it is desirable for the system to have an output port 14 such as a radio transceiver for transmitting a data structure 40 via low bandwidth transmissions. It may also be desirable for the system to operate in real time and consequently it may be desirable to reduce the amount of computation required by the processor 6 to produce the data structure 40.

The input file format 3 is a video file or stream. The chosen color scheme could be RGB, YUV YCC

Frame dropping was implemented. If the expected frame number is less than the actual frame number then the next frame is ordered to be ignored. This allows the program to catch up with the stream and avoid crashes. However when a frame is dropped it causes a jump in the video footage which will cause a problem when tracking. To solve this when a frame is ordered to be dropped the frame is stored and not processed. At the end of the footage all the dropped frames are processed and the results can be inserted in to the result data.

FIG. 1B illustrates a processing system 110 suitable for performing data set-up and behavior evaluation as illustrated in FIG. 5.

The system comprises a processor 106 connected to read from and write to a memory 108. The memory 8 stores computer program instructions 112 and data structure 40.

The computer program instructions 112 control the operation of the system 110 when loaded into the processor 106. The computer program instructions 112 provide the logic and routines that enables the electronic device to perform the methods illustrated in FIG. 5.

The computer program instructions may arrive at the system 110 via an electromagnetic carrier signal or be copied from a physical entity such as a computer program product, a memory device or a record medium such as a CD-ROM or DVD or be transferred from a remote server.

The system 110 also comprises a radio transceiver for communicating with the system 10 to receive the data structure 40 which is then stored in memory 108 by the processor 106.

The processor 106 is also connected to an input means 101 via which other data may enter the system 110.

Although the systems 10 and 110 are illustrated as separate entities in FIGS. 1A and 1B, in other implementations they may be integrated.

The tracking process 20 is illustrated in FIG. 2. The input 21 provided to the filter stage 22 may be a video file or a video stream. It the latter case, the output from the video camera memory buffer is provided to a filter 22.

At stage 22, the image is filtered to remove some noise using convolution. A kernel is passed iteratively over the whole image and the weighted sums of the pixels covered by the kernel at each position is computed.

The next stage 24 involves thresholding (also known as quantization). This separates the pixels of interest (foreground object/s) within an image from the background. It is the process of reducing the input image to a bi-level image (binarization). Every pixel (i, j) is examined against a threshold T and if its value is greater than T then it is given the value true and if its value is less than T then it is given the value false.

for each pixel ε image

| | |
|---|---|
| do | if P_{(i,j)} > T |

then P_{(i,j)} = true
else P_{(i,j)} = false

There are many ways for obtaining the value T some of which will be described here.

Mean thresholding is the simplest form of thresholding and it involves calculating the average of all of the pixel values and removing some constant C from it.

$$T = ( \frac{1}{N} {\sum }_{∀ ( i , j )} {P}_{( i , j )} ) - C$$

Where N is the total number of pixels in the image. The advantage of this method is that it is very quick but it is not robust to changes in light intensity over the image.

In adaptive thresholding, a window is passed over the image iteratively. At each position the average value of the pixels contained within the window is calculated and a constant C is subtracted to give the threshold.

$$∀ WT = ( \frac{1}{n \times m} {\sum }_{( n , m ) ε W} {P}_{( i , j )} ) - C$$

This has the advantage that there can be changes in light intensity over the image and objects will be identified consistently throughout the image. The disadvantages are that it is very slow as the number of pixels examined is very high.

Background removal can be used when experiments are being carried out on a constant background. An image of the background with no foreground objects is taken B, this image is used in conjunction with a current image which may contain foreground objects. In this case, the background image would be the test area and the other images would be each frame of the footage. The background image is subtracted from the current image on a pixel by pixel basis. This has the effect of creating a new image which only contains the foreground objects.

Alternatively, if the background is changing, such as bedding in home cage experiments, then background estimation can be used. This is the process of taking every Nth frame and using the sampled frames to build a set of frames. The frame set is of fixed size and as new frames are added old frames are removed in a first in first out ordering. When pixel values are averaged over the set of frames, moving objects are removed thus leaving an average background.

Pseudo Adaptive Thresholding is a novel thresholding technique. The method divides the image of size (h×w) up in to a number of windows N of size (h/q(N))×(w/q(N)) each of these windows is then treated as an individual image and mean thresholding is applied within the sub-image. As the sub-images are small compared to the original image, instead of using mean thresholding as described before, k-random pixels are chosen in each sub-image and these values are averaged to generate a threshold (minus a constant).

| for each W ε N | | | | |
|---|---|---|---|---|
| | | total = 0 | | |
| | | for i ← 0 to k | | |
| | | | | (i,j) = random pixel in W |
| do | {open oversize brace} | do | {open oversize brace} | |

total = total + P_{(i,j)}

T = (total/k) − C
THRESHOLD(T, W)

The algorithm performs well with light variations across the image and an optimum number of windows is between 9 and 16.

Adaptive Thresholding also performs well and the amount of background noise classified as foreground pixels can be very small however it is time consuming. It is a preferred technique if one does not wish to trade accuracy for speed. Otherwise, adaptive thresholding is preferred in conditions of variable lighting and mean thresholding is preferred in constant lighting conditions.

The next stage is an image cleaning stage 26. Image cleaning is the process of removing any noise that may be remaining after the previous image processing. After the process of image cleaning there should only be large solid regions left in the image.

Erosion is the process of iteratively taking the neighborhood of a pixel (the pixels surrounding it) over the whole image and if the number of true pixels in the neighborhood is less than a threshold then the pixel is set to false. This has the effect of removing spurs and protrusions from objects and it removes small amounts of noise as well. If two regions are barely touching it has the effect of separating them. The disadvantage of this is that details of the edges of foreground objects are lost.

Dilation is the opposite of erosion. If the number of true pixels in a neighborhood is greater than some threshold then that pixel is set to true. This has the effect of filling hollows in foreground objects and smoothing edges. However it may also increase the size of small regions that are actually noise.

Erosion and Dilation can be used together to smooth the edges of a foreground object and to remove unwanted small regions from the image.

It has been found that use of a dilation operator is redundant when filter 22 performs an averaging convolution as this provides much the same effect.

The next stage is pixel-group detection; stage 28. In this case, a pixel-group is defined as a contiguous region of foreground pixels in the image that relates to an object or an overlapping group of objects.

The pixel-groups are identified and assigned a unique label. The algorithm below recursively examines the (4-8 connected) neighborhood of each pixel to determine if any of the neighbors have been assigned a label. If they have not, then the pixel is assigned the current label, if they have, then the algorithm sets the label to the lowest of the neighboring labels.

label = 0
for each pixel ε binImage

| do if P_{(i,j)} = true | | |
|---|---|---|
| | | (label = label + 1 |
| then | {open oversize brace} | |
| | | SEARCH(label,i,j) |

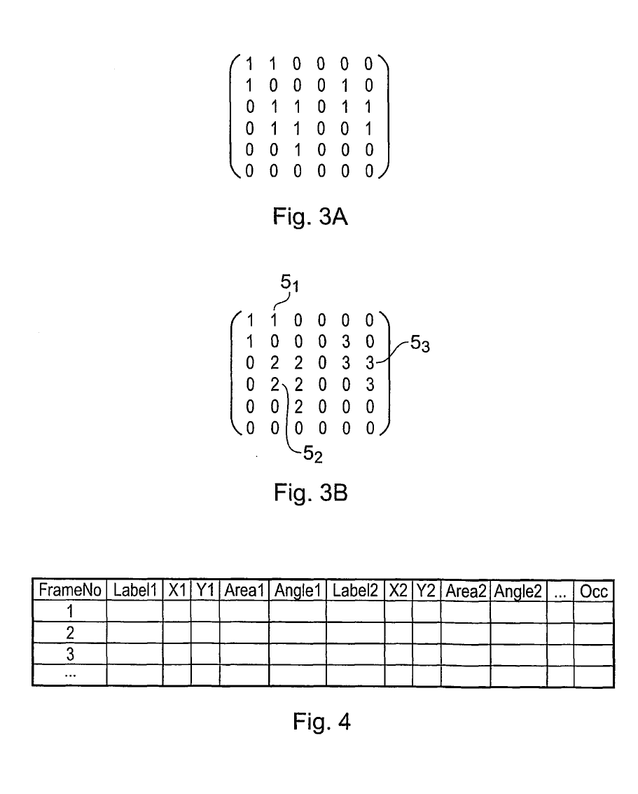

Thus the pixels illustrated in FIG. 3A are labeled as shown in FIG. 3B. FIG. 3B illustrates three different pixel-groups.

Occasionally there are pixel-groups left in the binary image that are not foreground objects. Upper and lower bounds are placed on the characteristics of allowed objects (e.g. area and/or eccentricity). Pixel-groups that represent a foreground objects always fall between the upper and lower bounds. Any pixel-groups outside the range of characteristics are ignored in the pixel-group detection and labeling process.

The pixel-group detection stage returns a list of pixel-groups that have been detected in the current frame although this may not be all of the objects in the frame due to occlusion.

The next stage is occlusion-event detection, stage 30.

A boundary for a pixel-group is defined as a region that encompasses or surrounds the group.

A boundary may be a true bounding box such as a simple rectangle defined by the topmost, leftmost, rightmost and bottommost points of the pixel-group. The advantage of this approach is that is it very quick to compute. However, it is not a good representation of the shape or area of the pixel-group and possibly includes a substantial area of background.

A boundary may be a fitted bounding box as described above from the perspective of its primary axis and orientation. The advantages of this method are that the computation required is still simple and the resulting rectangle typically contains only a small proportion of background.

A boundary may also be a fitted boundary such as an ellipse or polyhedron that best fits the pixel-group. For example, the ellipse with the minimum area that encompasses the pixel-group may be found using standard optimization techniques. However, the computation required is complex and requires a substantial amount of time to compute.

Alternatively an active contour model can be used to fit a boundary to the pixel-group. Yet another way to fit a pixel-group boundary is to extract edge/s using standard edge detection routines such as a sobel filter before line segmentation on the extracted edge(s) providing a polyhedron representation of the line. One line segmentation technique is to pick 2 points (A, B) opposite each other on the line and create a vector between these two points. When the furthest point along this line from the vector C is over some threshold T then the vector is split in two (AC, CB). This process is performed iteratively until no point is further than T from the extracted representation.

Although occlusion-event detection identifies the start and end of occlusion by utilizing the boundary of objects, additional object properties, some of which are listed below, provide a framework for managing object tracking during occlusion
label—this is the globally unique label for an object that identifies the object over time. i.e. the label remains the same over time.
x, y—this is the x and y coordinate of that object.
area—the object area.
angle—the object angle.
rect—The boundary of the object.
contains—A List that contains the unique labels currently associated with the detected object, or its own label if there are no others contained within it.
contained—A Boolean flag that states whether this object is contained within another's contains list.
possible—A list of unique labels that might be contained in this object. This is used to deal with ambiguities introduced by the splitting of a boundary that contains more than two objects.

Other properties which may be used, include but are not restricted to, eccentricity, velocity, acceleration, size in different dimensions. The contains-list and possible-list may also have associated probabilities e.g. a component-object is contained in a parent-object with a certain probability.

Object tracking during occlusion can be extended via the use of N kalman filters corresponding to the N component-objects in the scene. A kalman filter will, given a history of information for an object, provide a probabilistic value for its information in the current frame. This can be used in the decision making process to improve the reliability of the system when large numbers of merging and splitting operations take place or when there is a large amount of movements between frames.

An algorithm proposed by Fuentes and Velastin [“People Tracking in surveillance applications”, 2^{nd} IEEE International Workshop on Performance Evaluation on Tracking and Surveillance, PETS 2001] attempts to match bounding boxes of boundaries between frames. The assumption that is made for this to work is that the spatial movement is small compared to the temporal movement. i.e. there is always overlap between bounding boxes in consecutive frames.

If one defines two consecutive frames f(t) and f(t−1) which can both contain a differing number of boundaries accounting for occlusion i.e. a boundary may contain one or more objects. The correspondence between the two frames is defined by a pair of matching matrices Mₜ^{t-1} and Mₜ₋₁^{t}.

The Mₜ^{t-1} matrix matches the boundaries from a current frame to the boundaries of a previous frame. The matrix has N ordered rows and M ordered columns, where N represents the number of boundaries in the current frame and M represents the number of boundaries in the previous frame. A true value or values in a row indicates that the boundaries of the current frame associated with that row maps to the boundaries of the previous frame associated with the position or positions of the true value/s.

A matching string Sₜ^{t-1} is a single row of vectors, where each vector represents a boundary in the frame at time t and each vector represents, for that object, the associated object/s in the frame at time t−1. Thus the presence of a multi-value vector at the position corresponding to a particular boundary at time t indicates that multiple objects have merged to form that object and the vector identifies the component-object. The presence of the same vector at multiple positions indicates that the boundary identified by that vector has split. In addition, the presence of multiple true values in a row indicates that a boundary has split over time into multiple objects.

Using the matching string it is possible to define the following events:

Merging: Bᵢ(t−1)∪Bⱼ(t−1)≡Bₖ(t)⇄[Sₜ₋₁^{t}(i)=Sₜ₋₁^{t}(j)=k, Sₜ^{t-1}(k)=i∪j] (4.17)

Splitting: Bᵢ(t−1)≡Bⱼ(t)∪Bₖ(t)⇄[Sₜ₋₁^{t}(i)=j∪k, Sₜ^{t-1}(j)=Sₜ^{t-1}(k)=i] (4.18)

Entering: Bᵢ(t)≡New⇄[Sₜ₋₁^{t}(j)≠i∀j, Sₜ^{t-1}(i)=] (4.19)

Leaving: Bᵢ(t−1)≡Leaves⇄[Sₜ^{t-1}(j)≠i∀j, Sₜ₋₁^{t}(i)=] (4.20)

Corresponding: Bᵢ(t−1)≡Bⱼ(t)⇄[Sₜ₋₁^{t}(i)=j, Sₜ^{t-1}(j)=i] (4.21)

These operations taken from the work of Fuentes and Velastin (2001) allow us to detect when an occlusion is starting or finishing, when an object is entering or leaving and when a boundary matches one-to-one with another.

A further event can therefore be defined as:

NoMatch: Bᵢ(t)≡No Match⇄[Sₜ^{t-1}(i)=, Sₜ₋₁^{t}(j)=]

This states that if an object is leaving and entering in the same frame then it is really an error due to poor video footage and the objects are matched to each other as this tends to be more likely than an object entering or leaving the footage.

In the occlusion-event detection, stage 30, first the new boundaries for objects of the current frame are calculated, then the matching matrices and strings are generated by calculating the overlap between object boundaries in this frame with object boundaries in the previous frame. A list of events is subsequently created and for these events corresponding operations are carried out in stage 32 to generate additional information for each object. The process 34 by which information is extracted from a single object pixel-group is different to the process 36 by which information is extracted from a multiple-object pixel-groups.

At stage 32, the objects are updated. However, the updating operations performed depend upon the event detected at stage 30.

Various stage 32 events permitted are described below. Each event may be assigned a probability in that when multiple events are possible for an object or set of objects the probability of each event can be assigned by examining a history of events and relationships between them. This can be hard-coded or learned throughout the duration of the current or previous datasets.
OneOnOne(A,B)—This states that object A from the previous frame matches boundary B in the current frame.

If the contains-list variable of object A only contains one entry then the Label of A is copied in to the Label of B. A pixel-group analysis method 34 can be performed on the object B to obtain but is not restricted to, angle, area and position.

Otherwise if the contains-list variable has multiple entries (there is continuing occlusion) the contains-list and possible-list variables of A are copied to B, and an occlusion information generation method 36 is performed to obtain angle and position information for each object in the pixel-group. Each of the contained-list object areas are carried forward from the corresponding object in the previous frame. i.e. no attempt is made to calculate new areas for the occluded objects.
Merge([A,B],C)—This states that objects A and B from the previous frame merge to form boundary C in the current frame.

If merging has been detected then the contains-list variable of A and B are combined (a merge can involve more than two objects merging). This creates a contains-list variable for boundary C which represents the merging objects (as boundary A or B may have contained more than one object). Angle and position Information is then created for the contains-list of C using the occlusion information generation method 36 and matched to the corresponding previous data.

Each of the objects areas are carried forward from the previous frame. i.e. no attempt is made to calculate new areas for the occluded objects. The contained flag of each of the merging objects is set to true.
Split(A,[B,C])—This states that object A from the previous frame has split in to objects B and C in the current frame from a single boundary.

When a split is detected we define the total number of objects contained in A as S(a) and we define the number of objects that A is splitting into as N(s). Now we assume a split, as such B is assumed to contain (Sa−Na) objects and C is assumed to contain one object. C has its ‘possible’ object variable set to the contains-list of B.

The objects are assigned to B and C using the occlusion information generation method for each of the splitting objects and matching to the previous data.

If object A splits into B and C but the contains-list variable of object A does not contain enough entries to cover the split i.e. (Sa<Ns) then object A's possible variable is consulted. The size of the possible variable is P(a), the number of extra objects required to facilitate the split is (Ns−Sa). (Sa<Ns) entries are selected from the possible variable of object A and are used to ‘make up the numbers’. These entries are then deleted from the possible-list and contains-list variables of all other objects from the previous frame. The split then completes as previously outlined. Finally each splitting object has its contained flag set to false.

The pseudo code for the split operation is given below:

Algorithm B.5.1: SPLIT(A, Splitting)

S_{A} = A.contains.size( )
Nₛ = Splitting.size( )
possibleRequired = Nₛ − S_{A}
curData
if possibleRequired < 0

| then | | {orderedClosest = FINDCLOSEST(A.contains,Splitting) |
|---|---|---|
| | | orderedClosest = FINDCLOSEST(A.possible,Splitting) |
| else | {open oversize brace} | for i ← 0 to possibleRequired |

do {A.contains.add(orderedClosest(i))

for i ← 0 to (S_{A} − Nₛ)

do {Splitting(0).contains.add(A.contains(orderedClosest(i)))

for i ← (S_{A} − Nₛ) to Nₛ

| | | Splitting(i).contains.add(A.contains(orederdClosest(i))) |
|---|---|---|
| do | {open oversize brace} | |

Splitting(i).possible = Splitting(0).contains

for each s ε Splitting

| | | info = OCCINFGEN(s.contains.size, s.rect) |
|---|---|---|
| do | {open oversize brace} | |

curData.add(info)

BESTFIT(prevData(A.contains),curData)

Leave(A)—object A from the previous frame has left.

If object A has been detected as leaving then any entries in its possible-list that are not in any other objects possible-list are added to all other object possible-list. This covers the scenario that object A actually contained more than one object.
Enter(A)—boundary A in the current frame is new.

If boundary A has been detected as entering then it is assigned a new label and the pixel-group analysis method 34 is performed to obtain amongst many parameters its area, position and angle.

If boundary A actually contained more than one object then when it splits it will be discovered that there are not enough entries in the contains-list and possible-list variable. In this situation the splitting object would be treated as novel.
NoMatch(A,B)—object A from the previous frame matches nothing (is leaving), and boundary B in the current frame matches nothing (is new) therefore assume they match each other due to large spatial movements.

If a no match has been detected then all objects from the previous frame with no matches B(p) and all objects from the current frame with no matches B(c) are found and are assigned to each other using their central points and the best fit algorithm. Information is copied from each matched previous to current object as in a OneOnOne matching.

### Pixel-Group Analysis Method 34

This method is an example of one of many methods that can be used to obtain position, area and angle information for a pixel-group comprising a single object. When the pixel-group has been identified and labeled in the image the required properties must be extracted. Position can be found by simply summing the x and y positions of the pixels that belong to an object and dividing by the area. This gives the mean x and y position of the object. The angle may be found using a linear parameter model or a vector based approach.

A linear parameter model is a way to solve regression problems that tries to fit a linear model to a set of sample data. The advantage of this method is that it gives a very accurate estimation of the orientation of the object. The disadvantage is that the time taken for computation is high compared to the vector approach.

The vector based approach simply assumes that an object is longer from head to tail than it is from side to side. First the centre is found and then the point furthest from the centre is calculated. The vector between these two points is used to determine the orientation of the object.

### Occlusion Information Generation Method 36

This is used to obtain position, and angle information for each object in a pixel-group comprising multiple objects.

The pseudo code is:

Algorithm B.4.1: OCCINFGEN(n, Rect)

means = KMEANS(Rect,n,10)
for each mⱼ ε means

do {points_{J} = FINDFURTHESTPOINTFROM(m(j), Rect)

assignment = BESTFIT(means, points)
points = REORDER(points,assignment)
return (means,points)

First one defines the number of objects as the length of the contains-list for object A C(a). K-Means is performed with K=Length(C(a)) within the boundary of object A on the binary image. This generates the central points (means) P(n) for the contained objects. Next for each point P(n) in the object A, the point within the object with the largest Euclidean squared distance from P(n) is found, D(n). Finally all the P-values are assigned to the D-values using a best fit assignment method. The orientation of the vector between a P-value and an assigned D-value provides the angle data.

Now we have the data for the N objects that we know are contained in boundary A (and therefore boundary B), the calculated data must be matched to the data contained in object B from the previous frame. This is done in one of two ways depending on what the average distance between the calculated centers. Firstly, if the average distance between calculated centers is over some threshold T, then a best fit matching algorithm can be used to match the corresponding centre points from the previous frame to the current frame. When the average distance is less than T prediction methods such as a alman filter are required.

The output from the stage 32 is a data structure 40 such as that illustrated in FIG. 4. It includes for each frame of the video an entry for each object. The entry for each object contains the information fields.

### Conflicts

If it can be guaranteed that the number of objects in each frame throughout the dataset is constant then enter and leave operations must be due to errors. It is therefore useful to introduce a conflict resolution routine as part of the event detection stage 30, whereby enter and leave events can be replaced by no match events. After the initial round of error correction the filtered events are then analyzed to see if all the no matches can be resolved (i.e. there are enough objects in the previous and current frame to satisfy all the operations) if they can not then the operations that can not be satisfied are deleted.

Again this process may also be probabilistic, where given conflicts a probability can be assigned to operations that resolve the conflict given past experiences and information available about the predicted information of the objects involved in conflicting operations e.g. From a kalman filter.

The output from the tracking process 20, the data structure 40, may be processed at the location at which the tracking process was carried out or remotely from that location.

### Classifying Training Data

The data structure 40 produced by the tracking process 20 is used to reconstruct the interaction of objects. An expert interacts with an annotator by identifying periods of footage in which they believe the behavior they are looking for is satisfied. The expert classifications are recorded in a log file along with the corresponding parameter values from the data structure 40. The log file is a labeled data set of parameters and values (behavior satisfied or not). It is used by a behavioral learning algorithm to generate rules which correspond to the experts classification procedure.

### Behavioral Learning Algorithm

It is assumed that there certain parameters that can be measured from the interaction of the objects that correlate to certain behaviors of an object or objects. It may be possible that behaviors can not be identified from a single frame of footage as they may be exhibited over a previous time span before classification is possible. If there are n parameters defining an n-dimensional space, then it is assumed that data points characterizing different aspects of a particular behavior will form different clusters. Each cluster may be a volume in the n-dimensional space or a volume in some m-dimensional sub-space. Each cluster represents a behavioral rule for a particular aspect of the studied behavior.

The object of process 50 illustrated in FIG. 4 to receive a streaming data structure 40 and determine in real time if a predetermined behavior is occurring and if so which object or objects are involved in the behavior.

A set-up process 52 first characterizes the aspect(s) of the behavior as different ‘behavior’ volume(s). A behavior volume may span its own m-dimensional sub-space of the n-dimensional space.

The evaluation process 54 then processes received parameters to determine whether they fall within a behavior volume. If they do, the situation represented by the received parameters is deemed to correspond to the behavior.

### Set-Up Process

The set-up process 52 characterizes the aspect(s) of the behavior as different ‘behavior’ volume(s). A behavior volume may span its own m-dimensional sub-space of the n-dimensional space. A variety of dimensionally reducing processes for this approach include, but are not restricted to, Genetic Algorithms, Principal Component Analysis, Probabilistic PCA and Factor Analysis.

In the case of a genetic algorithm, the process generates a population of possible solutions, each solution defined by a chromosome of genes. The chromosome is designed as a set of measured parameter genes and a set of genes that control the fitness scoring process in the genetic algorithm. A genetic algorithm typically simulates greater longevity for fitter genes and also an increased likelihood of breeding. Some mutation of the genes may also be allowed.

The genes that control the scoring process may, for example, specify the number C of the clusters as an integer gene and the time period F over which behavior is tested as an integer gene. The measured parameter genes may be Boolean genes that can be switched on/off.

The advantage of a genetic algorithm is that one does not need to prejudge which measured parameters cluster or how they cluster to characterize the studied behavior or over what time period the behavior should be assessed. The genetic algorithm itself will resolve these issues.

At each iteration of the genetic algorithm, chromosomes are picked randomly (or using tournament selection) from a population and randomly one of three operations are performed.
Selection—move the chromosome into the intermediate population unchanged
Mutation—change one value randomly in the chromosome and move it to the intermediate population
Crossover—pick two chromosomes and randomly pick a point along the length of a chromosome and swap all the values of the two chromosomes after the split point. This generates two children and two parents. From these a number are picked to go through to the intermediate population. The two resulting chromosomes with the highest fitness may, for example, be entered into the intermediate population and the other two discarded.

At the end of each iteration each chromosome in the intermediate population has its fitness evaluated.

A fitness score is assigned to each chromosome solution using the log file 51 from the expert classification stage. In a possible solution chromosome, the b measured parameter genes that are switched on i.e. have a true value define a b dimensional sub-space of the n-dimensional parameter space defined by the measured parameters.

The expert log file, which records data points in the n-dimensional space and whether an expert considers each data point to be during the behavior, is used to form C clusters spanning the b dimensional sub-space of the n-dimensional parameter space. The clustering may be performed, for example, using Gaussian distributions or an extended K-means or C-means algorithm but is not restricted to these clustering methods.

Gaussian clustering fits ‘blobs’ of probability in the data space allowing a point to be given a probability that it belongs to each of the Gaussian distributions present. This can be useful in classification situations but here if the data point falls within any of the Gaussian distributions it will be classified as the behavior. Also with Gaussian distributions the confidence interval must be decided to give the best fit to the data which could cause complications.

The K-Means algorithm is a way of fitting k means to n data points. Initially the points in the data set are assigned to one of the k sets randomly and the centroid of each set is calculated.

$$J = {\sum }_{j = 1}^{K} {\sum }_{nε {S}_{j}} {\vert {x}_{n} - {μ}_{j} \vert}^{2}$$

Then we iterate through each point and calculate the nearest centroid to it based on the Euclidean squared distance. Each point is assigned to the set associated with the nearest centroid.

At the end of each iteration the centroids of the sets are re-calculated. This continues until a predefined number of iterations elapses or until there are no reassignments during an iteration. The pseudo code is given below:

Algorithm B.3.1: KMEANS(dataset,K,its)

point[ ]means
for i ← 0 to its

boolean reassigned = false
for each pᵢ ε dataset

for each sⱼ ε S

meansⱼ = DISTANCETOCLUSTER(p(i),s(j))
if meansⱼ < lowest Distance

| | | | |
|---|---|---|---|
| {open oversize brace} | do | {open oversize brace} | (closestCluster = j |

| | | | | |
|---|---|---|---|---|
| do | {open oversize brace} | then | {open oversize brace} | MOVEPOINTTOCLUSTER(p(i),s(j)) |

reassigned = true

if reassigned = false or i > its

then return (means)

K-means only fits means to the data points but it is possible to extend this to give each mean a bounding box and therefore make it a cluster. This is done by examining all the points that belong to a particular cluster (i.e. it is the nearest mean to that point) and creating a bounding box (in two dimensions, cube in three, hyper cube in more than three) by examining the furthest point from the mean in that cluster in each dimension. This generates a set of thresholds in each dimension. Any points belonging to a cluster that are too far away from the mean (user defined by a threshold T) are ignored to compensate for outliers in the data set (noisy data). The cluster is thus defined as a centre point in the n-dimensional space and a tolerance in each dimension. This tolerance is a threshold which states the maximum Euclidean squared distance an instance of a set of parameters can be from the defined centre point for it to fall within the cluster and be classified as an aspect of the behavior.

The threshold value T may be added as a gene of the chromosome used in the genetic algorithm. In addition, the temporal relationship of classification can also be learnt in this way and used in classification or for post-processing.

The defined C clusters are then used to assess the log file. Each data point from the log file that falls within a defined cluster C is labeled as exhibiting the behavior and each data point that falls without any of the defined clusters C is labeled as not exhibiting the behavior.

A fitness function for the chromosome is based on the correlation on a frame by frame basis of the algorithm's allocation of courtship behavior and the expert's allocation of courtship behavior over the past F frames of data. The better the correlation the fitter the chromosome.

The total fitness of the intermediate population is then found and the next population is constructed using the roulette wheel method. This assigns a fraction of size (chromosome fitness/total fitness) of the population to each chromosome in the intermediate population. This ensures that there are more of the fitter solutions in the next generation.

The stopping criteria is a set as a number of iterations (user defined) of a percentage correlation of the best solution with the experts classifications in the test data (user defined).

The result of the genetic algorithm is the single fittest or a group of the fittest chromosomes. In addition, the clusters associated with such chromosomes can be calculated.

The advantages of a genetic algorithm are that it is an any time algorithm. i.e. at any time it can be stopped and a valid solution can be returned as the amount of time it runs for increases the solution becomes better.

For flies, it is postulated that courtship interactions manifest themselves as the objects being oriented to each other in a certain set of ways within certain distance bounds. Thus possible parameters required are the relative distance, the angle between two objects and the x and y distances between objects. The x and y distances are needed because in courtship behavior one fly may follow another.

Thus in the example of the flies, it is assumed but not known that one or more of certain parameters such as area, relative position, relative orientation adopt a certain range of values when courtship behavior is occurring.

The measured parameter genes are, in this particular example, four Boolean genes which represent the four data values x distance, y distance, relative distance and relative angle. The scoring process genes are two integer genes which represent the number of clusters C to look for and the number of frames of past data to consider F.

The genetic algorithm in the set-up process 52 has fixed data points and behavior classifications and produces chromosomes and clusters.

The fittest chromosomes and their associated clusters may then be fixed. Then at the evaluation process 54, input data points from a data structure 40 are reduced to those that span the space spanned by the ‘on’ measured parameters of the fittest chromosome and then tested to see if they lie within the associated cluster. If they do they are automatically classified as exhibiting the behavior in output 56.

After classifying a data set the relationships between components of a behavior can be investigated. As the expert is identifying high level behaviors, and the algorithm is identifying relationships between objects, a single behavior may be made of more than one component (learned cluster). This can be achieved by looking at the temporal relationships between the components identified. The likelihood of a component value (or 0 if no component is matched) at a time point can be calculated using techniques such as a Hidden Markov Model to decide whether the assigned value is probable.

The behavior as a whole may be post-processed as the output from the algorithm is a list of Boolean values (or probabilities). These values may be smoothed to remove unlikely temporal relationships based on the behavior that is identified. Examples include the length of time a behavior is expressed over or the length of breaks in the behavior being expressed. An example of such techniques include passing a window containing a Gaussian distribution over the data values to smooth them.

Although embodiments of the present invention have been described in the preceding paragraphs with reference to various examples, it should be appreciated that modifications to the examples given can be made without departing from the scope of the invention as claimed. For example although the tracking and behavioral analysis has been described in relation to flies they may be used for the tracking and behavioral analysis of other moving objects such as independent biological organisms, animals capable of independent relative movement, rodents, flies, zebra fish and humans.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method for automatically characterizing a behavior of an object or objects, comprising:
processing object data to obtain a data set that records a measured parameter set for each object over time;
providing a learning input that identifies when the measured parameter set of an object is associated with a behavior;
processing the data set in combination with the learning input to determine which parameters of the parameter set over which range of respective values characterize the behavior; and
sending information that identifies which parameters of the parameter set over which range of respective values characterize the behavior for use in a process that uses the characteristic parameters and their characteristic ranges to process second object data and automatically identify when the behavior occurs.

2. A method as claimed in claim 1, wherein the independent moving objects are animals capable of independent relative movement.

3. A method as claimed in claim 2, wherein the animals are one of the animals selected from the group comprising: rodents; flies, zebra fish and humans.

4. (canceled)

5. (canceled)

6. (canceled)

7. A method as claimed in claim 1, wherein processing the data set in combination with the learning input to determine which parameters of the parameter set over which range of respective values characterize the behavior involves the use of a learning mechanism.

8. A method as claimed in claim 1, wherein processing the data set in combination with the learning input to determine which parameters of the parameter set over which range of respective values characterize the behavior involves the use of a genetic algorithm.

9. A method as claimed in claim 8, wherein chromosomes used in the genetic algorithm comprises a gene for each of the parameters in the measured parameter set that may be switched on or off.

10. A method as claimed in claim 8, wherein chromosomes used in the genetic algorithm comprises a gene that specifies the number of clusters of parameters necessary for characterizing the behavior.

11. A method as claimed in claim 8, wherein chromosomes used in the genetic algorithm comprises a gene that specifies a time period over which the fitness of a chromosome is assessed.

12. A method as claimed in claim 8, wherein a chromosome from a population of chromosomes used by the genetic algorithm, defines a parameter space and how many clusters the parameter space is divided into, and the extent to which the sub-set of the data set that lies within the clusters correlates with the sub-set of the data set associated with a behavior determines the fitness of the chromosome.

13. A method as claimed in claim 1 wherein the object data is video.

14. A method as claimed in claim 1, wherein the characterized behavior is an interaction of moving objects.

15. A record medium tangibly embodying computer program instructions which when loaded into a processor, enable the processor to perform steps in the method of claim 1.

16. A system for automatically characterizing a behavior of an object or objects, comprising:
means for providing a learning input that identifies when a measured parameter set of an object is associated with a behavior;
means for processing a data set, which records the measured parameter set for each object over time, in combination with the learning input to determine which parameters of the parameter set over which range of respective values characterize the behavior; and
means for outputting information that identifies which parameters of the parameter set over which range of respective values characterize the behavior.

17. A method of tracking one or more objects comprising:
processing first data to identify discrete first groups of contiguous data values that satisfy a first criterion or first criteria;
processing second subsequent data to identify discrete second groups of contiguous data values that satisfy a second criterion or second criteria;
performing mappings between the first groups and the second groups;
using the mappings to determine whether a second group represents a single object or a plurality of objects;
measuring one or more parameters of a second group when it is determined that the second group represents a single object;
processing a second group, when it is determined that the second group represents N (N>1) objects, to resolve the second group into N subgroups of contiguous data values that satisfy the second criterion or second criteria;
measuring the one or more parameters of the sub groups; and
mapping the plurality of subgroups to the plurality of objects.

18. A method as claimed in claim 17, wherein mapping the plurality of subgroups to respective objects is based upon matching a measured parameter.

19. (canceled)

20. (canceled)

21. A method as claimed in claim 17, wherein mapping the plurality of subgroups to respective objects is based upon a history of a measured parameter.

22. A method as claimed in claim 17, wherein mapping the plurality of subgroups to respective objects is according to a first method if a third criterion or criteria are satisfied and wherein mapping the plurality of subgroups to respective objects is according to a second method if a fourth criterion or criteria are satisfied.

23. (canceled)

24. (canceled)

25. A method as claimed in claim 17, wherein the first data is a first video frame, the second data is a second subsequent video frame, and the data values are pixel values and wherein mapping the plurality of subgroups to respective objects is based upon a measure of the distance of a subgroup in the second frame from objects in the first frame, so long as the shortest one of the distances exceeds a threshold value and is otherwise based upon a measure of the motion of a moving object derived from previous frames including the first frame and the distance of a subgroup in the second frame from a predicted position of the moving object, the method further comprising: processing a video frame to identify discrete groups of contiguous pixel values that satisfy a criterion or criteria involves dividing the first video frame of size (h×w) into a plurality of windows and performing mean thresholding individually to each window.

26. (canceled)

27. (canceled)

28. A method as claimed in claim 17, wherein performing mappings between the first groups and the second groups involves the identification of a ‘no match’ event in which one of the first groups appears to have entered (or left) and one of the second groups appears to have simultaneously left (or entered) and forcing the mapping of the one of the first groups that appears to have entered (or left) with the one of the second groups that appears to have simultaneously left (or entered) and further comprising resolving conflicts in mappings between the first groups and the second groups in dependence upon whether it appears that one or more of the second groups has entered or left compared to the first frame.

29-33. (canceled)

34. A system for tracking one or more objects comprising:
a processor operable to process first data to identify discrete first groups of contiguous data values that satisfy a first criterion or first criteria;
process second subsequent data to identify discrete second groups of contiguous data values that satisfy a second criterion or second criteria;
perform mappings between the first groups and the second groups;
use the mappings to determine whether a second group represents a single object or a plurality of objects;
measure one or more parameters of a second group when it is determined that the second group represents a single object;
process a second group, when it is determined that the second group represents N (N>1) objects, to resolve the second group into N subgroups of contiguous data values that satisfy the second criterion or second criteria;
measure the one or more parameters of the sub groups; and
map the plurality of subgroups to the plurality of objects.
